(19) United States
(12) Patent Application Publication
(10) Pub. No.: US 2016/0203701 A1
(43) Pub. Date: Jul. 14, 2016

(54) Emergency Alert Bracelet and Method of Use

(71) Applicant: Anthony Woodard, Washington, DC (US)

(72) Inventor: Anthony Woodard, Washington, DC (US)

(21) Appl. No.: 14/993,319

(22) Filed: Jan. 12, 2016

Related U.S. Application Data
(60) Provisional application No. 62/103,149, filed on Jan. 14, 2015.

(51) Int. Cl. G08B 25/01; G08B 5/36; G08B 3/10

(52) U.S. Cl. CPC G08B 25/016; G08B 3/10; G08B 5/36

(57) ABSTRACT

An emergency alert bracelet for alerting others and drawing attention to the user when the user is in an emergency situation. The bracelet comprises a strap that can be adjustably secured on the wrist of a user. The bracelet includes a housing thereon that includes a warning light, a control switch, and one or more indicator lights. When a user operates the control switch, the warning light illuminates or flashes, an alarm unit produces an audible alert, and optionally a GPS chip transmits the location of the user to a third party, such as an emergency contact. The housing further includes a power source and indicator lights for indicating the charge status of the power source. Additionally, a charging port is provided for charging the power source of the device.

### CROSS REFERENCE TO RELATED APPLICATION

This application claims the benefit of U.S. Provisional Application No. 62/103,149 filed on Jan. 14, 2015. The above identified patent application is herein incorporated by reference in its entirety to provide continuity of disclosure.

### BACKGROUND OF THE INVENTION

### Field of the Invention

The present invention relates to emergency alert devices. More specifically, the present invention provides an emergency alert bracelet comprising a strap with a housing thereon, wherein the housing includes a warning light, an alarm unit, and optionally a GPS unit. The user can actuate a control switch on the housing in order to cause the warning light to illuminate, the alarm to produce an audible alert, and the GPS unit to transmit the user's location to a third party, such as an emergency contact or an emergency call center.

Walking or traveling alone can be dangerous and increases the risk that a person will be mugged or assaulted. This is particularly true at night and in urban areas or high-crime areas. If a person is attacked, the person may have no way of calling for help or otherwise drawing attention to themselves in order to obtain assistance and escape. While many people carry a cell phone with them at all times, the person is likely to be unable to use their cell phone to call for help during a confrontation. Thus, in an emergency situation, a person may have difficulty obtaining assistance from others and has no means for warding off the attacker.

Devices have been disclosed in the prior art that relate to monitoring and tracking devices. These include devices that have been patented and published in patent application publications. U.S. Patent Application Publication Number 2010/0267361, U.S. Pat. No. 6,889,135, U.S. Pat. No. 5,652,570, U.S. Pat. No. 8,669,865, and U.S. Pat. No. 6,930,614 relate to tracking or monitoring devices that include GPS units in order to allow the user to transmit their location to a third party or that allow the user to be monitored or tracked.

These prior art devices have several known drawbacks. Such devices fail to provide means for drawing attention to the user aside from transmitting the user's location information. Thus, the user is unable to draw attention to himself or herself or otherwise alert people in the nearby area for assistance and must instead wait for the police or an emergency response team to arrive. Further, the devices in the prior art do not provide means for warding off an attacker, such as an alarm unit or a warning light.

In light of the devices disclosed in the prior art, it is submitted that the present invention substantially diverges in design elements from the prior art and consequently it is clear that there is a need in the art for an improvement to existing emergency alert bracelet devices. In this regard the instant invention substantially fulfills these needs.

### SUMMARY OF THE INVENTION

In view of the foregoing disadvantages inherent in the known types of emergency alert bracelets now present in the prior art, the present invention provides a new emergency alert bracelet wherein the same can be utilized for providing convenience for the user when drawing attention to himself or herself for the purpose of obtaining assistance from others during an emergency situation.

It is therefore an object of the present invention to provide a new and improved emergency alert bracelet device that has all of the advantages of the prior art and none of the disadvantages.

It is another object of the present invention to provide an emergency alert bracelet device comprising a strap with a housing therein, wherein the housing includes a warning light, a control switch, and indicator lights, and wherein operating the control switch causes the warning light to flash and an alarm unit to produce an audible alert.

Another object of the present invention is to provide an emergency alert bracelet device that includes a illuminable light and an alarm unit for warding off attackers by drawing attention to the user and the confrontation.

Yet another object of the present invention is to provide an emergency alert bracelet device adapted to alert others in the nearby area that the user is in danger, and that may optionally include a GPS unit that can transmit the user's location to a third party, such as an emergency response team.

A further object of the present invention is to provide an emergency alert bracelet device comprising a power source and indicator lights adapted to indicated the charge status of the power source.

An additional object of the present invention is to provide an emergency alert bracelet device comprising one or more rechargeable batteries enclosed within the housing, wherein the housing includes a port adapted to receive a charging cable or charging device.

Another object of the present invention is to provide an emergency alert bracelet device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the emergency alert bracelet of the present invention.

FIG. 2 shows a schematic diagram of the components of the emergency alert bracelet.

### DETAILED DESCRIPTION OF THE INVENTION

Reference is made herein to the attached drawings. Like reference numerals are used throughout the drawings to depict like or similar elements of the emergency alert bracelet of the present invention. For the purposes of presenting a brief and clear description of the present invention, the preferred embodiment will be discussed as used for warding off an attacker and alerting others in the nearby area that the user is in danger and/or requires assistance. The figures are intended for representative purposes only and should not be considered to be limiting in any respect.

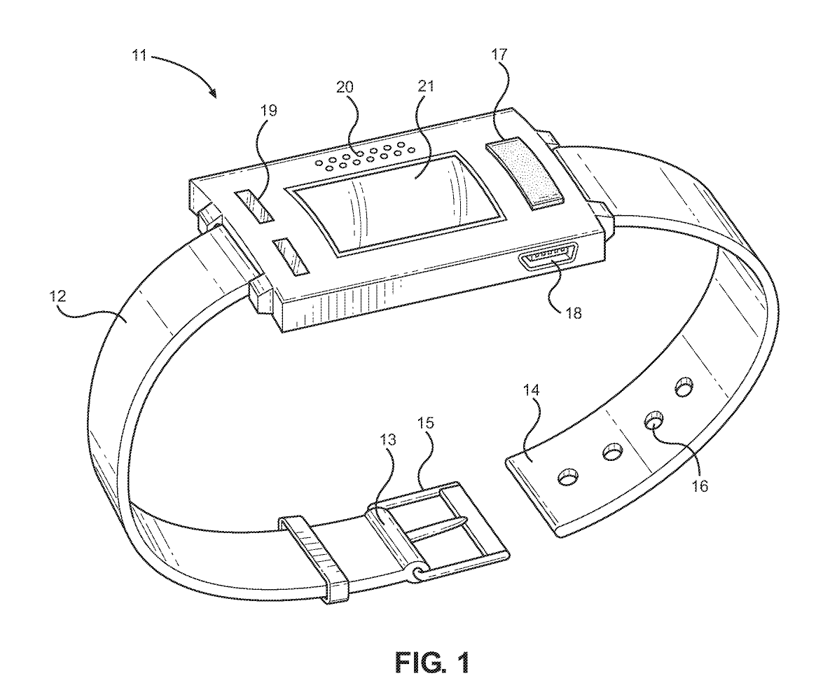

Referring now to FIG. 1, there is shown a perspective view of an embodiment of the emergency alert bracelet of the present invention. The emergency alert bracelet 11 comprises a housing disposed on an elongated strap 12 having a first end 13 and a second end 14. The strap 12 may be one solid strap, or may include a first section attached to a first side of the housing and a second section attached to a second side of the housing. The first end 13 of the strap 12 includes a fastener 15 thereon adapted to engage with a fastener on the second end 14 of the strap 12. In the illustrated embodiment, the fastener 15 comprises a buckle adapted to engage with any of a plurality of holes 16 disposed on the second end 14 of the strap 12. This allows the bracelet 11 to be adjustably secured to the wrist of a user. However, in alternate embodiments, other types of fasteners may be used to adjustably secure the bracelet 11 to the user's wrist, such as a clasp or a buckle having male and female mating portions.

The housing comprises a warning light 21 and a control switch 17 thereon. The warning light 21 is preferably centrally located on the housing. The warning light 21 preferably comprises a halogen light or other light having a high-brightness. The warning light 21 is adapted to draw the attention of others in the nearby area, and may also be used to blind an attacker. Thus, the warning light 21 must be sufficiently bright to achieve these purposes. When the control switch 17 is actuated, the warning light 21 may be steadily illuminated or may flash intermittently, such as in a strobing pattern, depending upon the embodiment. The warning light 21 can be turned off by actuating the control switch 17 a second time.

The housing further includes an alarm unit that includes a speaker 20 for producing an audible alert. The audible alert may be a single high-pitched tone, a siren, an intermittent or pulsing tone, or any of various other loud, audible alerts. The alarm unit is activated when the user presses the control switch 17 and continues to produce an audible alert until the control switch 17 is actuated a second time.

The housing encloses a power source adapted to power the warning light 21 and alarm unit. The power source preferably comprises one or more rechargeable batteries, however in alternate embodiments the power source may include disposable batteries, a solar panel, or any of various other power sources. In embodiments having a rechargeable battery, one or more indicator lights 19 are also positioned on the housing to indicate the charge status of the power source. This helps the user to determine when the device needs to be charged so that the bracelet 11 has sufficient power so that it can be used in the event of an emergency. The housing may further include a charging port 18 for receiving a charging cable or other charging device for recharging the rechargeable batteries.

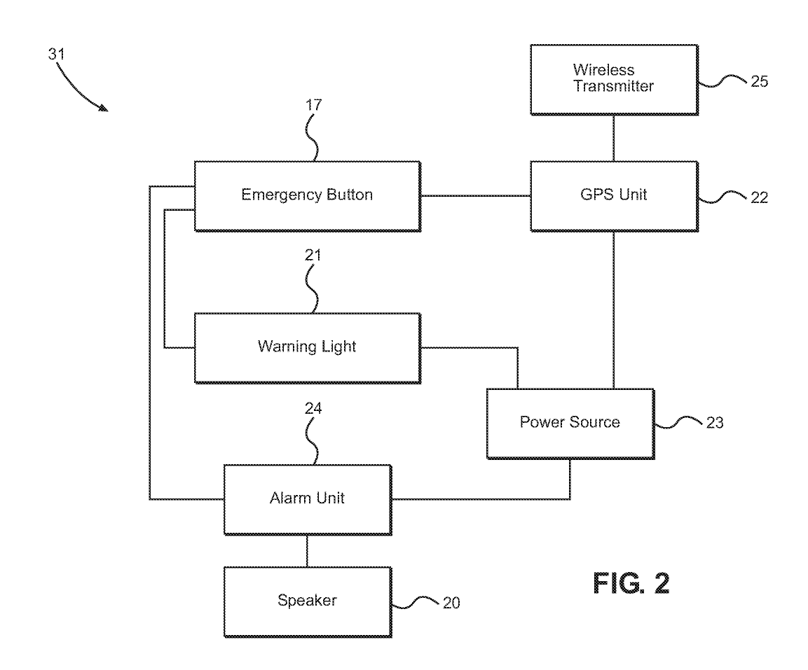

Referring now to FIG. 2, there is shown a schematic diagram of the components of the emergency alert bracelet. The housing encloses a control circuit comprising a control switch 17 or emergency button that is operably connected to the warning light 21 and alarm unit 24 so that the warning light 21 illuminates and the alarm unit 24 produces an audible alert via the speaker 20 thereon when the control switch 17 is actuated. In this way, the user can easily actuate the control switch 17 in order to activate the warning light 21 and alarm unit 24 so as to draw the attention of those in the nearby area to obtain assistance, and may scare off the attacker due to the attention the bracelet draws to the user and attacker.

In some embodiments, the emergency alert bracelet further comprises a GPS unit 22 and a wireless transmitter 25. When the user actuates the control switch 17, the GPS unit 22 is adapted to transmit the user's location to a third party, such as an emergency contact, the police, or an emergency response team. This allows the user to convey his or her location in the event that the person is kidnapped or is unconscious. The emergency contact or response team can then easily locate and render aid or assistance to the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An emergency alert bracelet, comprising:
a strap adapted to be adjustably secured on a wrist of a user;
a housing disposed on said strap comprising a control switch, a warning light, and an alarm unit;
a control circuit operably connected to said control switch, said warning light, and said alarm unit;
wherein said warning light is adapted to illuminate and said alarm unit is adapted to produce an audible alert when said control switch is actuated.

2) The emergency alert bracelet of claim 1, wherein said alarm unit comprises a speaker.

3) The emergency alert bracelet of claim 1, wherein the control circuit further comprises a GPS chip and a wireless transceiver, wherein actuation of said control switch is adapted to transmit a location as determined by said GPS chip to a wireless signal receiver.

4) The emergency alert bracelet of claim 1, wherein said housing further includes a power source.

5) The emergency alert bracelet of claim 4, wherein said housing further includes one or more indicators lights adapted to indicate a charge status of said power source.

6) The emergency alert bracelet of claim 4, wherein said housing further includes a port adapted to receive a charging cable, such that said power source of said housing can be recharged.

7) The method of seeking help during an emergency, comprising the steps of:
providing an emergency alert bracelet comprising a strap having a housing therein, wherein the housing comprises a control switch, a warning light, and an alarm unit;
actuating said control switch, wherein actuation of said control switch is adapted to cause said warning light to illuminate and said alarm unit to produce an audible alert.

8) The method of seeking help during an emergency of claim 7, further comprising the step of:
providing a GPS chip and a wireless transceiver in said housing, wherein said GPS chip is adapted to determine a location of said housing;
wherein the step of actuating said control switch causes said wireless transceiver to transmit said location to a wireless receiver.
